(19) United States
(12) Patent Application Publication
(10) Pub. No.: US 2017/0264993 A1
(43) Pub. Date: Sep. 14, 2017

(54) HEAD SET AND HEAD SET APPARATUS

(71) Applicant: Panasonic Intellectual Property Management Co., Ltd., Osaka (JP)

(72) Inventors: SHUJI YAMASHITA, Nara (JP); SUGURU NAKAO, Hyogo (JP); HIROSHI KUNIMOTO, Osaka (JP); TEPPEI KOIDO, Osaka (JP)

(21) Appl. No.: 15/412,208

(22) Filed: Jan. 23, 2017

(30) Foreign Application Priority Data
Mar. 9, 2016 (JP) 2016-046232

(51) Int. Cl. H04R 1/10; H04R 3/12; H04R 29/00

(52) U.S. Cl. CPC H04R 1/1075; H04R 29/001; H04R 3/12; H04R 2460/13

(57) ABSTRACT

A head set configured to be worn on the head of a human body includes a communicator configured to communicate with an external device, speakers configured to output, as voices, signals received by the communicator, detectors configured to detect whether or not the head set is being worn on the head, a vibration generator configured to generate vibrations for applying vibrations to the human body, a supporting portion configured to support the communicator, the speakers, the detectors and the vibration generator, and a controller configured to cause the vibration generator to vibrate, when the communicator is being in a signal-arriving state, and the head set not being worn on the head is being detected by the detectors.

### BACKGROUND

1. Technical Field

The present disclosure relates to a head set configured to be worn on a head of a human body, and a head set apparatus including such a head set.

2. Description of the Related Art

Unexamined Japanese Patent Publication No. 2003-319022 discloses a cellular phone apparatus including a bone-conduction speaker. The user of this cellular phone apparatus can know calling from a communication partner and can start talks, by bringing the bone-conduction speaker into contact with his or her cheek or the like.

### SUMMARY

A head set according to the present disclosure is a head set configured to be worn on a head of a human body and includes a communicator configured to communicate with an external device, a speaker configured to output, as a voice, a signal received by the communicator, a detector configured to detect whether or not the head set is being worn on the head, a vibration generator configured to generate a vibration for applying the vibration to the human body, a supporting portion configured to support the communicator, the speaker, the detector and the vibration generator, and a controller configured to cause the vibration generator to vibrate, when the communicator is being in a signal-arriving state, and the head set not being worn on the head is being detected by the detector.

### BRIEF DESCRIPTION OF THE DRAWINGS

FIG. 1 is a perspective view of a head set according to a first exemplary embodiment;

FIG. 2 is a front view of the head set according to the first exemplary embodiment;

FIG. 3 is a block diagram illustrating the structure for controlling the head set according to the first exemplary embodiment;

FIG. 4 is a side view illustrating a case where the head set according to the first exemplary embodiment is being worn on a head;

FIG. 5 is a front view illustrating a case where the head set according to the first exemplary embodiment is being worn on the head;

FIG. 6 is a side view illustrating a case where the head set according to the first exemplary embodiment is not being worn on the head;

FIG. 7 is a perspective view illustrating an end portion in the head set according to the first exemplary embodiment, in an enlarging manner;

FIG. 8 is a flow chart illustrating operations of the head set according to the first exemplary embodiment before the start of a talk;

FIG. 9 is a perspective view of a head set according to a second exemplary embodiment;

FIG. 10 is a perspective view illustrating a case where the head set according to the second exemplary embodiment is being worn on a head;

FIG. 11 is a perspective view illustrating a case where the head set according to the second exemplary embodiment is not being worn on the head; and

FIG. 12 is a view illustrating an example of a head set apparatus according to another exemplary embodiment.

### DETAILED DESCRIPTION

The head set according to the present disclosure is used for taking with a partner existing at a remote location, through wireless communication, for example. The head set is usually used in a state of being worn on the head of the user. However, when the head set is not used, the head set may be disengaged from the head, for example, by being hung on the neck or the like. In such cases, even if the partner generates voices in order to start a talk, the user can not be aware of the voices from the partner, which makes it impossible to start a talk. The head set according to the present disclosure has a structure which will be described later, in order to enable smooth start of a talk.

Hereinafter, exemplary embodiments will be described in detail, with reference to the drawings, as required. However, unnecessarily detailed descriptions will be omitted, in some cases. For example, matters which have been already well known will not be described in detail, and structures which are substantially identical will not be described redundantly, in some cases.

This is for the sake of preventing the following descriptions from being unnecessarily redundant, in order to allow those skilled in the art to easily understand them.

Further, the accompanying drawings and the following descriptions are provided for enabling those skilled in the art to sufficiently understand the present disclosure. These accompanying drawings and these following descriptions are not intended to restrict the spirits defined by the claims.

### First Exemplary Embodiment

Hereinafter, a first exemplary embodiment will be described with reference to the drawings.

[1-1. The Structure of a Head Set]

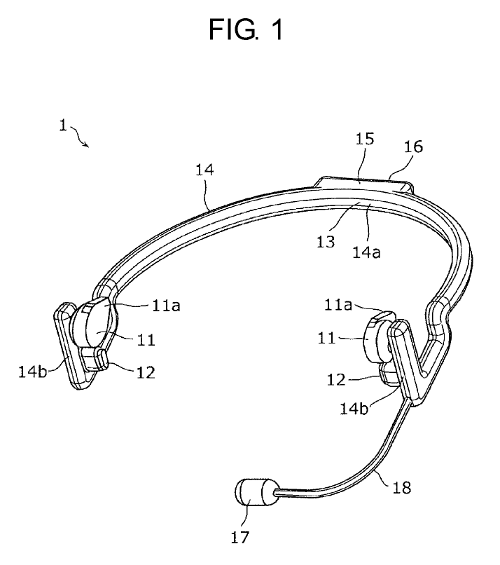

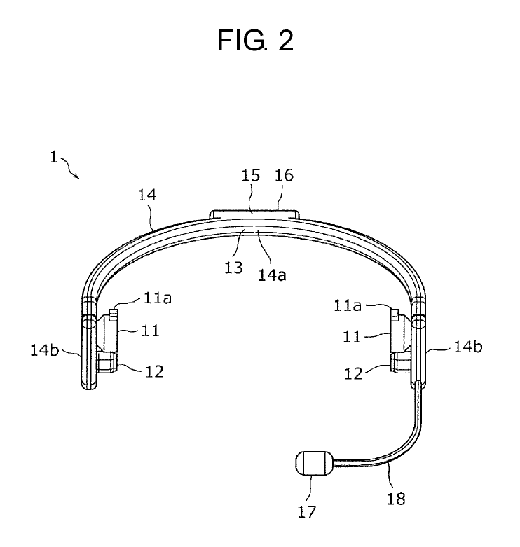

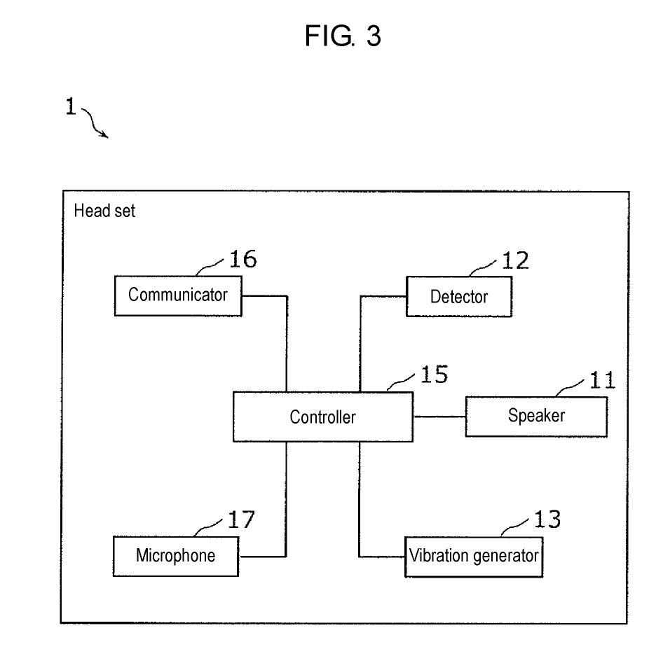

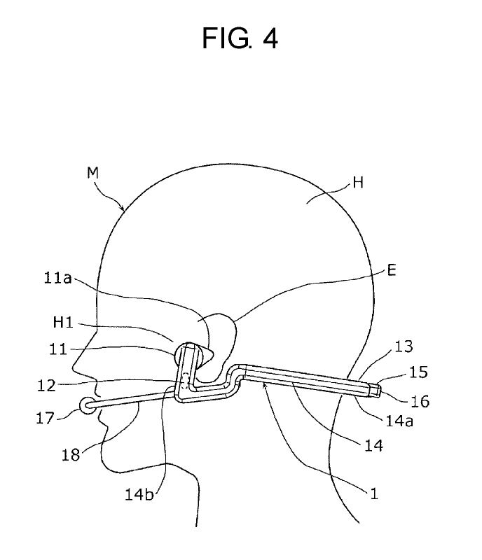

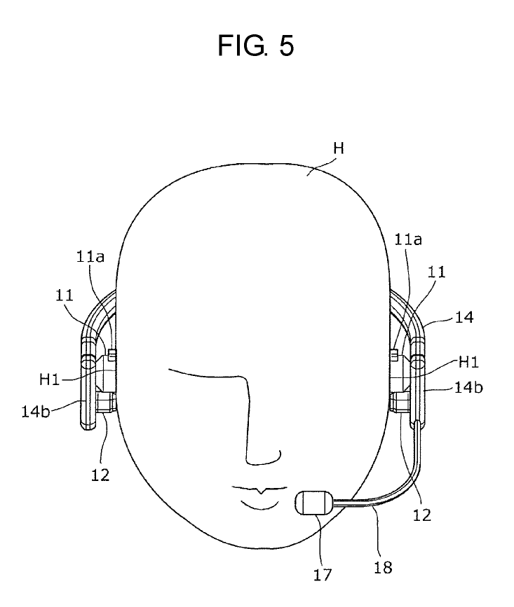

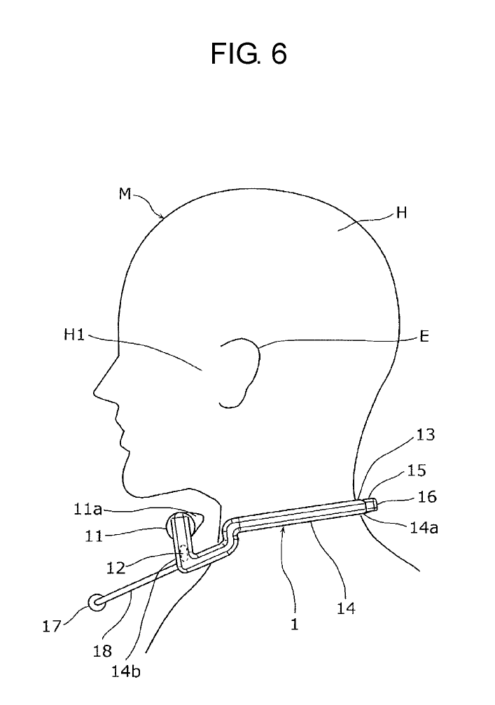

FIG. 1 is a perspective view of head set 1 according to the first exemplary embodiment, FIG. 2 is a front view of the same, and FIG. 3 is a block diagram illustrating the structure for controlling head set 1. FIG. 4 is a side view illustrating a case where head set 1 is being worn on head H, and FIG. 5 is a front view of the same. FIG. 6 is a side view illustrating a case where head set 1 is not being worn on head H.

As illustrated in FIGS. 1 to 3, head set 1 includes communicator 16, a pair of speakers 11, a pair of detectors 12, vibration generator 13, controller 15, and supporting portion 14. Supporting portion 14 has a U shape and includes opposite end portions 14b opposing each other, and center portion 14a positioned between opposite end portions 14b. Note that, center portion 14a of supporting portion 14 refers to a portion around the center of supporting portion 14 when supporting portion 14 is viewed along the U shape. The pair of speakers 11 are supported on the respective opposite end portions 14b in such a way as to oppose each other. The pair of detectors 12 are supported on the respective opposite end portions 14b in such a way as to oppose each other. Communicator 16, vibration generator 13 and controller 15 are supported in center portion 14a of supporting portion 14. Further, microphone 17 is mounted to one of end portions 14b of supporting portion 14, through microphone mounting portion 18. Further, speakers 11 and detectors 12 are not limited to a pair of speakers and a pair of detectors and can be also provided on only one of end portions 14b.

Communicator 16 communicates with an external device possessed by a communication partner, in a wireless manner. Communicator 16 is constituted by an antenna, a wireless module and the like. As the communication scheme, a frequency band of a 422 MHz band or a 440 MHz band is used, for example. Further, in cases where communicator 16 communicates with the external device, through a relay unit (not illustrated) for relaying communication with the external device, for example, a frequency band of a 2.4 GHz band, such as that for Bluetooth (trademark), is used, as the communication scheme for communicator 16.

Speakers 11 output, as voices, signals received by communicator 16 and amplified by controller 15. As illustrated in FIGS. 4 and 5, speakers 11 are provided on supporting portion 14 such that they come into contact with skins H1 positioned in front of the ears E, when head set 1 has been worn on head H. More specifically, each of speakers 11 is a bone-conduction speaker having a vibration plate made of metal. Vibrations generated by speakers 11 are mainly transmitted to the auditory nerve, through the cranial bones in human body M, from skins H1 in front of the ears. The user of head set 1 can recognize voices from the communication partner through the bone conduction.

Detectors 12 detect whether or not head set 1 is being worn on head H of the user. Detectors 12 are constituted by, for example, pressure-sensitive sensors, temperature sensors, capacitance-type tactile sensors, optical sensors, mechanical switches or the like. Detectors 12 are provided, such that they come into contact with human body M and detect head set 1 being worn on head H only when head set 1 has been worn on head H. More specifically, detectors 12 are provided on end portions 14b of supporting portion 14 under speakers 11. Thus, as illustrated in FIGS. 4 and 5, when head set 1 has been worn, detectors 12 come into contact with skins (human body M) positioned beneath skins H1 in front of the ears and detect head set 1 being worn on head H. Further, as illustrated in FIG. 6, when head set 1 is being hung on the neck (when head set 1 is not being worn on head H), head set 1 is in contact with human body M, but detectors 12 do not come into contact with human body M and do not detect that head set 1 is being worn on head H.

Electric signals resulted from detection by detectors 12 are transmitted to controller 15. Controller 15 converts the signals resulted from the detection by detectors 12 into voltages. Further, based on the magnitudes of the voltages, controller 15 determines whether or not detectors 12 are detecting human body M (whether or not they are in contact with human body M).

Supporting portion 14 is mainly formed from a resin material. Inside supporting portion 14, there are provided aggregates such as wires, and wirings (wirings for connecting controller 15, communicator 16, speakers 11, detectors 12 and vibration generator 13 and the like). Supporting portion 14 has a U shape and is configured such that supporting portion 14 can be hung on the neck by being brought into contact with the rear of the neck at center portion 14a of supporting portion 14. Opposite end portions 14b of supporting portion 14 have a column shape extending vertically, and the pair of speakers 11 are provided on the upper sides of opposite end portions 14b while the pair of detectors 12 are provided on the lower sides of opposite end portions 14b. Center portion 14a interiorly has a space, and there are provided communicator 16, vibration generator 13 and controller 15 within the space. Head set 1 has a substantially bilaterally-symmetric (linearly-symmetric) shape.

Further, supporting portion 14 has elasticity and is prone to bend at portions other than center portion 14a of supporting portion 14. More specifically, supporting portion 14 is configured such that the portions other than center portion 14a can bend to change the distance between opposite end portions 14b opposing each other. The elastic force of supporting portion 14 is adjusted such that speakers 11 are not separated from skins H1 in front of the ears and, also, are prevented from excessively pressing skins H1, when head set 1 has been worn on head H.

Further, supporting portion 14 is formed in such a way as to detour beneath ears E from opposite end portions 14b and to extend up to center portion 14a positioned behind head H, when head set 1 has been worn on head H. Since supporting portion 14 detours beneath ears E, the user can easily wear glasses. Further, since supporting portion 14 is formed in such a way as to extend up to center portion 14a positioned behind head H, the user can easily wear a helmet or a hat. Further, center portion 14a and the occiput do not come into contact with each other, and there is an interval therebetween.

Vibration generator 13 generates vibrations to apply vibrations to human body M. As such vibrations, vibrations outside the audible range are used, in order to prevent them from being mixed with voices output from speakers 11. The frequencies of such vibrations can be either higher or lower than the audible range. Vibration generator 13 is constituted by a piezo-electric device, or a motor having a rotational shaft provided with an eccentric weight, for example.

As illustrated in FIG. 6, vibration generator 13 is provided in supporting portion 14 such that it is proximal to the rear of the neck, when head set 1 is being hung on the neck by being disengaged from head H. If vibration generator 13 is caused to vibrate in the state of being proximal to the neck, the vibrations are directly transmitted to human body M without interposing air therebetween, which allows the user of head set 1 to easily recognize the vibrations.

Voices generated from human body M (user) are input to microphone 17. Microphone 17 is disposed such that microphone 17 is positioned in front of the mouth of the user, when head set 1 is used. The voices input to microphone 17 are converted into electrical signals by controller 15, and these electrical signals are transmitted to communicator 16.

Controller 15 is constituted by a CPU (Central Processing Unit), a RAM (Random Access Memory), and a ROM (Read Only Memory), and the like. Controller 15 amplifies the signals received by communicator 16 and outputs the amplified signals to speakers 11. Further, controller 15 converts voices input to microphone 17 into electrical signals and transmits the electrical signals to the external device through communicator 16.

In head set 1 according to the present exemplary embodiment, controller 15 determines whether or not communicator 16 is being in a signal-arriving state. If communicator 16 is being in a signal-arriving state, and head set 1 not being worn on head H is being detected by detectors 12, controller 15 causes vibration generator 13 to vibrate. Through these vibrations, the user is notified that head set 1 is not being worn, so that the user is urged to wear head set 1. This enables smoothly starting a talk.

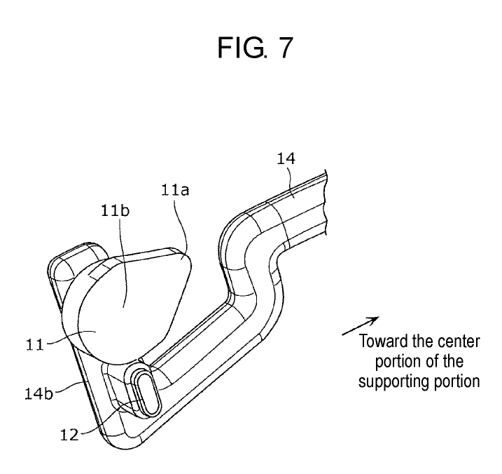

Hereinafter, there will be further described the shape of speakers 11, and the positional relationship between speakers 11 and detectors 12. FIG. 7 is a perspective view illustrating end portion 14b in head set 1, in an enlarging manner.

As illustrated in FIG. 7, speakers 11 include column portion 11b having a column shape, and protruding portion 11a which protrudes from column portion 11b toward center portion 14a of supporting portion 14. Protruding portion 11a protrudes toward center portion 14a of supporting portion 14, more than detectors 12. In other words, detectors 12 are positioned closer to end portion 14b (in the opposite side from center portion 14a) than the protruding end of protruding portion 11a.

Since speakers 11 are partially protruded toward center portion 14a more than detectors 12, for example, as illustrated in FIG. 6, if head set 1 is moved forwardly and rearwardly in a state where head set 1 is disengaged from head H and supporting portion 14 is hung on the neck, speakers 11 impinge on the neck at first, which inhibits detectors 12 from impinging on the neck. With this structure, when head set 1 is being disengaged from head H, even if vibration generator 13 is caused to vibrate, detectors 12 are inhibited from detecting the neck and the like. Therefore, when head set 1 is being disengaged from head H, it is possible to suppress provision of erroneous information indicating that head set 1 is being worn. Further, column portions 11b of speakers 11 can be also increased in diameter, so that speakers 11 partially protrude toward center portion 14a more than detectors 12.

[1-2. Operations of the Head Set]

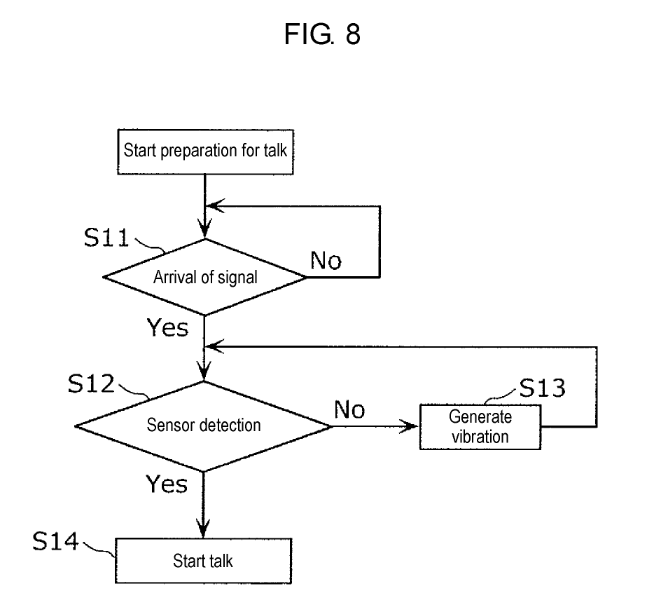

There will be described operations of head set 1 having the aforementioned structure, before start of a talk. FIG. 8 is a flow chart illustrating operations of head set 1 before the start of a talk.

At first, controller 15 determines whether or not communicator 16 is being in a signal-arriving state, in starting a talk (S11). More specifically, controller 15 determines whether or not communicator 16 is receiving a call signal from the external device. If communicator 16 is not being in a signal-arriving state (No in S11), controller 15 stands by without proceeding to the next step.

If communicator 16 is being in a signal-arriving state (Yes in S11), controller 15 proceeds to the next step, and controller 15 determines whether or not detectors 12 are detecting human body M (S12). If detectors 12 are detecting human body M (Yes in S12), it is deemed that head set 1 is being worn on head H, and a talk is started (S14).

On the other hand, if detectors 12 are not detecting human body M (No in S12), it is deemed that head set 1 is not being worn on head H, and vibration generator 13 is caused to vibrate (S13). Through the vibrations, the user is urged to wear the head set 1. Then, on recognizing the vibrations, the user wears head set 1. With this wearing, detectors 12 are caused to detect human body M (Yes in S12), and a talk is started (S14).

Further, if there is an arriving signal in the state where head set 1 is being worn (Yes in step S11), controller 15 can also cause vibration generator 13 to vibrate or can cause speakers 11 to generate a notification sound, in order to notify the user of the arrival of the signal from the communication partner. Further, if No in step S12, controller 15 can also notify the communication partner of the fact that the user is not wearing head set 1, through communicator 16.

[1-3. Effects and the Like]

As described above, head set 1 configured to be worn on head H of human body M according to the present exemplary embodiment includes communicator 16 configured to communicate with an external device, speakers 11 configured to output, as voices, signals received by communicator 16, detectors 12 configured to detect whether or not head set 1 is being worn on head H, vibration generator 13 configured to generate vibrations for applying vibrations to human body M, supporting portion 14 configured to support communicator 16, speakers 11, detectors 12 and vibration generator 13, and controller 15 configured to cause vibration generator 13 to vibrate, when communicator 16 is being in a signal-arriving state, and head set 1 not being worn on head H is being detected by detectors 12.

With this structure, if head set 1 not being worn is detected, vibration generator 13 is caused to vibrate to transmit the vibrations to human body M, which can urge the user to wear head set 1. Therefore, even when the user is not wearing the head set 1, it is possible to cause him or her to wear head set 1, thereby enabling smooth start of a talk.

Further, in the present exemplary embodiment, speakers 11 can be configured to transmit voices to human body M through bone conduction, by being brought into contact with human body M.

With this structure, voices and from the communication partner can be easily recognized, in noise environments. For example, in cases of using speakers configured to vibrate the eardrums in construction sites and the like, the voices from the partner are mixed with peripheral noises and cannot be easily heard. However, by transmitting sounds to the human body through bone conduction as in the present exemplary embodiment, it is possible to make it easier to hear voices from the partner.

Further, in the present exemplary embodiment, vibration generator 13 can be configured to generate vibrations outside the audible range.

With this structure, the vibrations from vibration generator 13 can be easily distinguished from voices or peripheral noises. This allows the user to easily recognize the vibrations from vibration generator 13, which enables smoothly starting talks.

Further, in the present exemplary embodiment, detectors 12 can be provided on supporting portion 14 such that they come into contact with human body M to detect human body M when head set 1 has been worn on head H. Controller 15 can be configured to determine that head set 1 is not being worn on head H, when detectors 12 are not detecting human body M.

As described above, based on information about detection by detectors 12, it is possible to accurately determine whether or not head set 1 is being worn on head H. This enables smoothly starting talks.

Further, in the present exemplary embodiment, supporting portion 14 can have a U shape and can have elasticity, vibration generator 13 can be provided in center portion 14a of supporting portion 14, and detectors 12 can be provided on end portions 14b of supporting portion 14.

With this structure, in cases where head set 1 is not desired to be worn on head H, for example, head set 1 can be brought into a state of being disengaged from head H such that supporting portion 14 with the U shape is hung on the neck. Even in such cases, by causing vibration generator 13 to vibrate, it is possible to apply vibrations through the neck, thereby providing notification of arrival of signals. Therefore, even when the user is not wearing head set 1 on his or her head H, it is possible to notify the user of arrival of signals, which enables smoothly starting talks.

Further, in the present exemplary embodiment, speakers 11 can be provided on end portions 14b of supporting portion 14, and speakers 11 can be partially protruded toward center portion 14a of supporting portion 14 more than detectors 12.

With this structure, for example, if supporting portion 14 is moved forwardly and rearwardly in a state where head set 1 is disengaged from head H and supporting portion 14 in head set 1 is hung on the neck, speakers 11 impinge on the neck at first, which inhibits detectors 12 from impinging on the neck. Therefore, when head set 1 is being disengaged from head H, even if vibration generator 13 is caused to vibrate, detectors 12 are inhibited from detecting the neck and the like. Therefore, when head set 1 is being disengaged from head H, it is possible to suppress provision of erroneous information indicating that head set 1 is being worn.

### Second Exemplary Embodiment

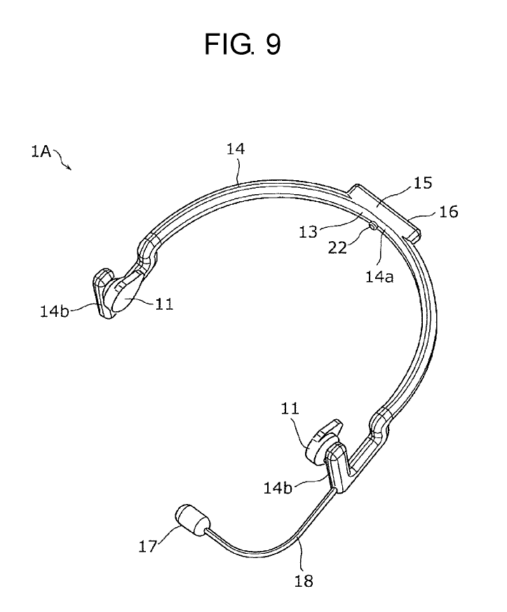

Hereinafter, with reference to FIGS. 9 to 11, a second exemplary embodiment will be described.

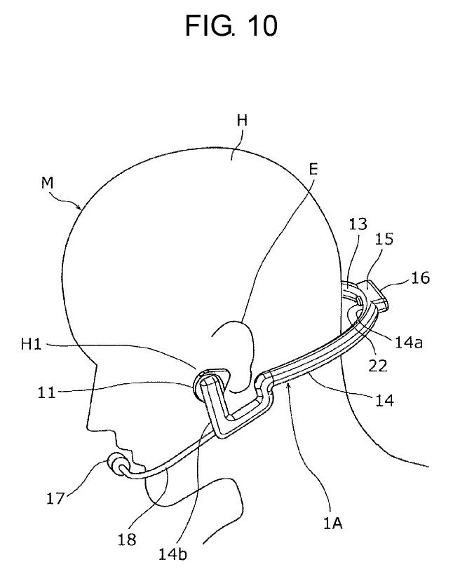

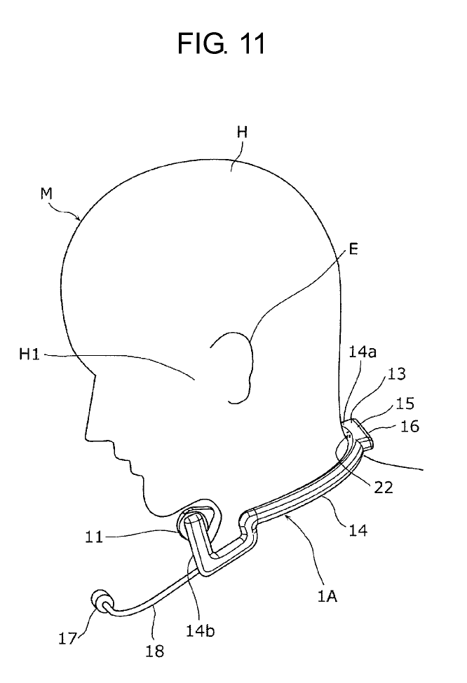

FIG. 9 is a perspective view of head set 1A according to the second exemplary embodiment. FIG. 10 is a perspective view illustrating a case where head set 1A is being worn on head H, and FIG. 11 is a perspective view illustrating a case where head set 1A is not being worn on head H.

In head set 1A, detector 22 is supported on center portion 14a of supporting portion 14. Namely, in center portion 14a of supporting portion 14, there are provided detector 22, communicator 16, vibration generator 13 and controller 15.

As illustrated in FIG. 10, detector 22 is provided on supporting portion 14, such that detector 22 does not come into contact with human body M and does not detect human body M, when head set 1A has been worn on head H. More specifically, when head set 1A has been worn on head H, detector 22 is disposed in such a way as to be spaced apart from the occiput and detector 22 does not detect human body M. On the other hand, as illustrated in FIG. 11, when head set 1A has been disengaged from head H and supporting portion 14 has been hung on the neck, detector 22 comes into contact with the skin of the rear of the neck to detect human body M.

Controller 15 determines that head set 1A is not being worn on head H, when detector 22 is detecting human body M. Further, if communicator 16 is being in a signal-arriving state, and head set 1A not being worn on head H is being detected through detector 22, controller 15 causes vibration generator 13 to vibrate. Through these vibrations, the user is notified that head set 1A is not being worn, so that the user is urged to wear head set 1A.

As described above, head set 1A configured to be worn on head H of human body M according to the present exemplary embodiment includes communicator 16 configured to communicate with an external device, speakers 11 configured to output, as voices, signals received by communicator 16, detector 22 configured to detect whether or not head set 1A is being worn on head H, vibration generator 13 configured to generate vibrations for applying vibrations to human body M, supporting portion 14 configured to support communicator 16, speakers 11, detector 22 and vibration generator 13, and controller 15 configured to cause vibration generator 13 to vibrate, when communicator 16 is being in a signal-arriving state, and head set 1A not being worn on head H is being detected by detector 22.

With this structure, if head set 1A not being worn is detected, vibration generator 13 is caused to vibrate to transmit the vibrations to human body M, which can urge the user to wear head set 1A. Therefore, even when the user is not wearing head set 1A, it is possible to cause the user to wear head set 1, thereby enabling smooth start of a talk.

Further, in the present exemplary embodiment, detector 22 is provided on supporting portion 14 such that it does not come into contact with human body M and does not detect human body M, when head set 1A has been worn on head H, and controller 15 determines that head set 1A is not being worn on head H when detector 22 is detecting the human body.

As described above, based on information about detection by detector 22, it is possible to accurately determine whether or not head set 1A is being worn on head H. This enables smoothly starting talks.

### Other Exemplary Embodiments

As described above, the first and second exemplary embodiments have been described, as illustrations of the techniques disclosed in the present application. However, the techniques according to the present disclosure are not limited thereto and can be also applied to exemplary embodiments which properly make, thereto, changes, substitutions, addition, omission and the like. Further, the respective components described in the aforementioned first and second exemplary embodiments can be also combined to provide new exemplary embodiments.

Therefore, hereinafter, other exemplary embodiments will be illustrated.

While, in the first and second exemplary embodiments, communicator 16 configured to directly communicate with the external device has been illustrated, as communicator 16 in head set 1, 1A, head set 1, 1A can be also configured to communicate with an external device through a relay unit.

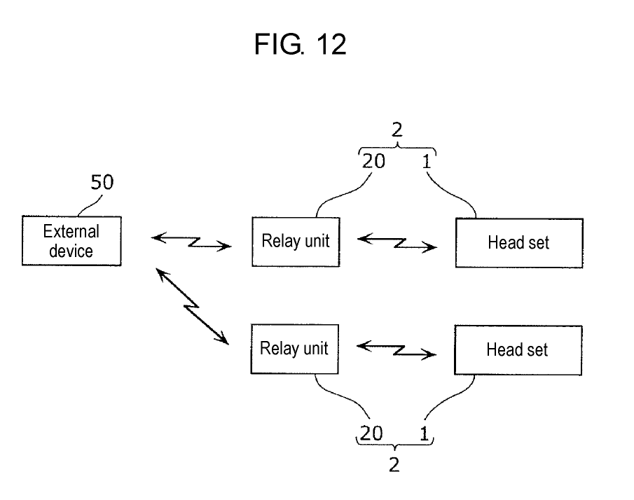

FIG. 12 is a view illustrating an example of head set apparatus 2 including head sets 1.

Head set apparatus 2 includes head sets 1, and relay units 20 for relaying communication between head sets 1 and external device 50. A single relay unit 20 is provided in association with each single head set 1.

External device 50 is constituted by a master-device transceiver, for example, and includes a communicator, a speaker, a microphone, a manipulation portion, a display portion and a controller.

Relay units 20 are possessed by users and are usually used at positions distant from external device 50. Relay units 20 are slave-device transceivers, for example, and include a communicator, a manipulation portion, and a controller. External device 50 and relay units 20 communicate with each other in a wireless manner, using a frequency band of a 422-MHz band or a 440-MHz band, for example.

Communicators 16 in head sets 1 and the communicators in relay units 20 communicate with each other in a wireless manner, through WiFi (trademark) or communication schemes using a frequency band of a 2.4-GHz band, such as Bluetooth (trademark), for example.

With head set apparatus 2 according to the present exemplary embodiment, it is possible to simplify the wireless module configuration of communicators 16 in head sets 1, which enables reduction of the weights of head sets 1.

As described above, the exemplary embodiments have been described as illustrations of the techniques according to the present disclosure. For coping therewith, the accompanying drawings and the detailed descriptions have been provided.

Accordingly, the components described in the accompanying drawings and the detailed descriptions may include not only components essential for overcoming the problem, but also components which are unessential for overcoming the problem, for the sake of illustrations of the aforementioned techniques. Therefore, it should not be instantly recognized that these unessential components are essential, for the reason that these unessential components are described in the accompanying drawings and the detailed descriptions.

Further, the aforementioned exemplary embodiments are merely for illustrating the techniques according to the present disclosure and, therefore, various changes, substitutions, addition, omission and the like can be made within the scope of the claims and equivalents thereof.

For example, while in the first exemplary embodiment, vibration generator 13, communicator 16 and controller 15 are provided in center portion 14a of supporting portion 14, the present disclosure is not limited thereto, and vibration generator 13, communicator 16 and controller 15 can be also provided between center portion 14a and end portions 14b.

Further, while in the first exemplary embodiment, there has been illustrated an example where center portion 14a of supporting portion 14 is disposed behind head H when head set 1 has been worn, the present disclosure is not limited thereto, and center portion 14a can be also configured to be disposed above head H.

Further, while in the first exemplary embodiment, there has been illustrated an example where supporting portion 14 is formed in such a way as to detour below ears E when head set 1 has been worn, the present disclosure is not limited thereto, and supporting portion 14 can be also formed to be along the upper sides of ears E such that the supporting portion 14 can be hung on ears E.

Further, while in the first exemplary embodiment, there has been illustrated an example where speakers 11 are configured to transmit sounds through bone conduction, the present disclosure is not limited to bone conduction, and sounds from speakers 11 can be also radiated to the insides of the external auditory canals to be transmitted to the eardrums and, then, can be transmitted to the auditory nerve.

What is claimed is:

1. A head set configured to be worn on a head of a human body, the head set comprising:
a communicator configured to communicate with an external device;
a speaker configured to output, as a voice, a signal received by the communicator;
a detector configured to detect whether or not the head set is being worn on the head;
a vibration generator configured to generate a vibration for applying the vibration to the human body;
a supporting portion configured to support the communicator, the speaker, the detector and the vibration generator; and
a controller configured to cause the vibration generator to vibrate, when the communicator is being in a signal-arriving state, and the head set not being worn on the head is being detected by the detector.

2. The head set according to claim 1, wherein
the speaker is configured to transmit the voice to the human body through bone conduction, by being brought into contact with the human body.

3. The head set according to claim 1, wherein
the vibration generator is configured to generate a vibration outside an audible range.

4. The head set according to claim 1, wherein
the detector is provided on the supporting portion such that the detector comes into contact with the human body to detect the human body when the head set has been worn on the head, and
the controller is configured to determine that the head set is not being worn on the head, when the detector is not detecting the human body.

5. The head set according to claim 1, wherein
the supporting portion has a U shape and has elasticity,
the vibration generator is provided in a center portion of the supporting portion, and
the detector is provided on an end portion of the supporting portion.

6. The head set according to claim 5, wherein
the speaker is provided on an end portion of the supporting portion, and the speaker partially protrudes toward the center portion of the supporting portion relative to the detector.

7. The head set according to claim 1, wherein
the detector is provided on the supporting portion such that the detector does not come into contact with the human body and does not detect the human body, when the head set has been worn on the head, and
the controller is configured to determine that the head set is not being worn on the head when the detector is detecting the human body.

8. The head set according to claim 1, further comprising
a microphone to which a voice generated from the human body is input.

9. A head set apparatus comprising
the head set according to claim 1, and
a relay unit configured to relay communication between the head set and an external device.
